(19) United States
(12) Patent Application Publication
(10) Pub. No.: US 2021/0295818 A1
(43) Pub. Date: Sep. 23, 2021

(54) SPEECH OUTPUT METHOD, DEVICE AND MEDIUM

(71) Applicant: BEIJING BAIDU NETCOM SCIENCE AND TECHNOLOGY CO., LTD., Beijing (CN)

(72) Inventor: Jiaying HUANG, Beijing (CN)

(21) Appl. No.: 17/034,080

(22) Filed: Sep. 28, 2020

(30) Foreign Application Priority Data
Mar. 17, 2020 (CN) 202010187465.8

(51) Int. Cl. G10L 13/00

(52) U.S. Cl. CPC G10L 13/00

(57) ABSTRACT

Embodiments of the present disclosure disclose a speech output method and apparatus, a device and a medium, and relate to speech processing technologies. Examples of the method include: determining a target text to be processed; matching the target text with a local text database to determine a preset text corresponding to the target text; and determining, based on the preset text, output speech of the target text from a local speech database to output the output speech; wherein the local speech database is pre-configured based on a correspondence between a text and speech.

### CROSS REFERENCE TO RELATED APPLICATION

This application is based on and claims priority to Chinese patent application No. 202010187465.8, filed on Mar. 17, 2020, the entire content of which is hereby incorporated by reference into this disclosure.

### FIELD

Embodiments of the present disclosure relate to computer technologies, specifically, to speech processing technologies, and more particularly, to a speech output method, a device and a medium.

### BACKGROUND

With the popularization of computer technologies, speech interaction is widely applied to various fields, such as smart navigation and smart home. In a process of using a vehicle-mounted device for voice navigation or using a smart speaker for a dialogue, both the vehicle-mounted device and the smart speaker need to support a text to speech (TTS) function. Text to speech includes online text to speech and offline text to speech.

### SUMMARY

In a first aspect, an embodiment of the present disclosure discloses a speech output method, including: determining a target text to be processed; determining a preset text corresponding to the target text by matching the target text with a local text database; and determining, based on the preset text, output speech of the target text from a local speech database to output the output speech. The local speech database is pre-configured based on a correspondence between a text and speech.

In a second aspect, an embodiment of the present disclosure discloses an electronic device. The electronic device includes at least one processor; and a storage device communicatively connected to the at least one processor. The storage device stores an instruction executable by the at least one processor, and when the instruction executed by the at least one processor, the processor implements a speech output method. The speech output method includes: determining a target text to be processed; determining a preset text corresponding to the target text by matching the target text with a local text database; and determining, based on the preset text, output speech of the target text from a local speech database to output the output speech. The local speech database is pre-configured based on a correspondence between a text and speech.

In a third aspect, an embodiment of the present disclosure discloses a non-transitory computer-readable storage medium. The storage medium has a computer instruction stored thereon. The computer instruction is configured to make a computer implement a speech output method. The speech output method includes: determining a target text to be processed; determining a preset text corresponding to the target text by matching the target text with a local text database; and determining, based on the preset text, output speech of the target text from a local speech database to output the output speech. The local speech database is pre-configured based on a correspondence between a text and speech.

### BRIEF DESCRIPTION OF THE DRAWINGS

The accompanying drawings are used for a better understanding of the solution, and do not constitute a limitation to the present disclosure.

FIG. 1 is a flowchart of a speech output method according to an embodiment of the present disclosure.

FIG. 2 is a flowchart of a speech output method according to another embodiment of the present disclosure.

FIG. 3 is a flowchart of a speech output method according to yet another embodiment of the present disclosure.

FIG. 4 is a schematic diagram of a speech output apparatus according to an embodiment of the present disclosure.

FIG. 5 is a block diagram of an electronic device according to an embodiment of the present disclosure.

### DETAILED DESCRIPTION

Exemplary embodiments of the present disclosure are described below with reference to the accompanying drawings, which include various details of embodiments of the present disclosure to facilitate understanding, and should be considered as merely exemplary. Therefore, those skilled in the art should recognize that various changes and modifications may be made to embodiments described herein without departing from the scope and spirit of the present disclosure. Also, for clarity and conciseness, descriptions of well-known functions and structures are omitted in the following description.

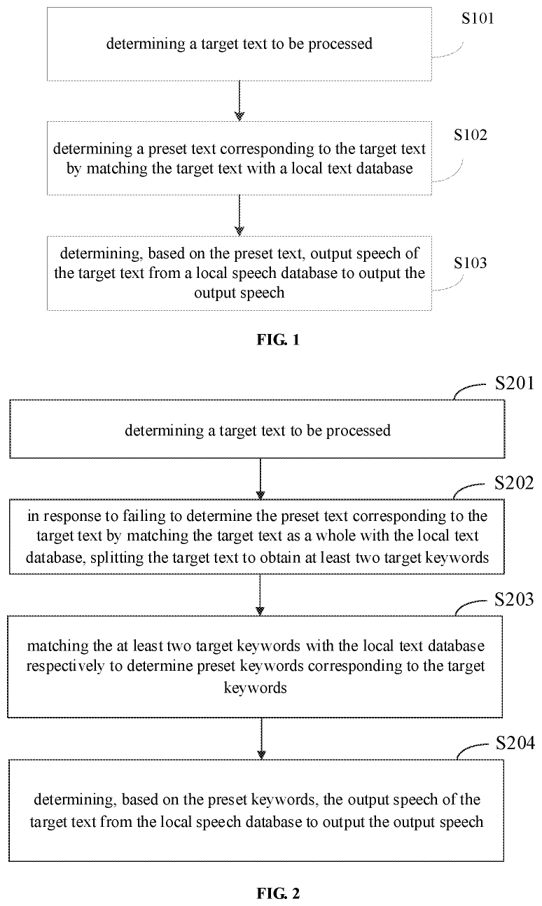

FIG. 1 is a flowchart of a speech output method according to an embodiment of the present disclosure. The embodiment may be applied to a situation where an interaction device may output human speech or human-like speech in offline speech interaction. “Offline” means that the interaction device cannot connect to the Internet currently. The method according to the embodiment may be executed by a speech output apparatus that may be implemented by software and/or hardware, and may be integrated on any electronic device that has computing capabilities and supports speech interaction functions, such as a mobile terminal, a smart speaker, a vehicle-mounted terminal, and so on. The vehicle-mounted terminal includes an in-vehicle terminal.

As illustrated in FIG. 1, the speech output method according to the embodiment may include the following.

At block S101, a target text to be processed is determined.

The target text refers to a text corresponding to speech that the interaction device feedbacks based on user requirements. For example, in a navigation process using an in-vehicle terminal, a text corresponding to a navigation sentence to be broadcasted by the in-vehicle terminal is the target text.

At block S102, a preset text corresponding to the target text is determined by matching the target text with a local text database.

In the offline speech interaction scene of the embodiment, when the interaction device needs to perform speech output, the interaction device does not directly enable any offline text to speech method integrated on the interaction device to perform text to speech processing on the target text; instead, in a state that the offline text to speech method is not enabled, the interaction device first performs local matching between the local text database with the target text to determine the preset text, and then determines the output speech from the local speech database based on the preset text. Text matching includes matching the target text as a whole sentence with the local text database, or splitting the target text into words and matching the target text in a granularity of words with the local text database. The offline text to speech method according to the embodiment refers to any available offline text to speech algorithm or offline text to speech engine.

Both the local text database and the local speech database are databases independent of existing offline text to speech methods. In detail, the local speech database is pre-configured based on a correspondence between a text and speech. The speech in the local speech database is pre-collected human speech, thereby ensuring the quality of the speech output in an offline state and reducing the impact of mechanical speech on user experience. The text corresponding to the speech in the local speech database forms the local text database, and the local text database may be a part of the local speech database. In addition, the local text database and the local speech database may be stored based on a relationship of key-value pairs. For example, the preset text in the local text database is determined as a key name, and the speech in the local speech database is determined as a specific value.

For different speech interaction scenes, for example, navigation, question and answer interaction, etc., the preset text in the local text database and the speech in the local speech database may be flexibly set based on requirements such as common words in speech interaction scenes. In detail, reusable short sentences and/or words may be preferably set based on the granularity of sentences and/or words.

At block S103, output speech of the target text is determined, based on the preset text, from a local speech database to output the output speech.

If the target text is successfully matched with the local text database, that is, there is the same text as the target text in the local text database, the output speech of the target text may be determined based on the preset text, and then fed back to a user. If the target text is not successfully matched with the local text database, there is no matching local speech output in the local text database. At this time, the offline text to speech method integrated on the interaction device may be adopted to perform speech synthesis on the target text to ensure the normal implementation of speech interaction. Illustratively, the speech output method according to the embodiment may be applied to an offline navigation scene. The local speech database includes navigation terms, and the interaction device may be an in-vehicle terminal. In the offline navigation process, the in-vehicle terminal may broadcast navigation speech based on a navigation path, for example, output navigation speech “turn left on the road ahead”, “go straight ahead 100 meters” and so on. Considering that a probability of the vehicle-mounted terminal being in the offline state is relatively high during a navigation process, determining the output speech through the local text matching optimizes the navigation speech and prevents mechanical navigation speech from affecting navigation experience of a user.

In addition, the speech stored in the local speech database may be in any audio format and has undergone certain encoding processing. After the output speech of the target text is obtained through local text matching, the output speech may be decoded to obtain original audio stream data (that is, pulse code modulation (PCM) stream). The original audio stream data is stored in the buffer of the interaction device for playback.

With the technical solution according to the embodiment, in offline speech interaction scenes, the local text database is preferably used for text matching to determine the preset text, and then the preset text is used to determine the output speech from the local speech database. The preset local speech database stores the high-quality human speech. In addition, the solution according to the embodiment does not directly enable the offline text to speech. Therefore, the solution according to the embodiment solves a problem of a mechanical sense of speech outputted in the offline state through the offline text to speech manner, optimizes the output speech when a device supporting speech interaction is in the offline state, improves the anthropomorphic level of the output speech, and reduces the impact of the mechanical speech on the user experience.

FIG. 2 is a flowchart of a speech output method according to another embodiment of the present disclosure, which is optimized and extended based on the above technical solution, and may be combined with the above optional implementations. As illustrated in FIG. 2, the method may include the following.

At block S201, a target text to be processed is determined.

At block S202, in response to failing to determine the preset text corresponding to the target text by matching the target text as a whole with the local text database, the target text is split to obtain at least two target keywords.

For example, the target text to be processed is “turn left on the road ahead”. If “turn left on the road ahead” may be completely matched with the local text database, it means that there is complete speech corresponding “turn left on the road ahead” in the local speech database, and thus the complete speech may be output directly. If “turn left on the road ahead” does not match with the local text database completely, the target text is split into, for example, target keywords “turn left”, “on the road”, and “ahead”. The target keywords are matched with the local text database one by one to determine corresponding preset keywords. The granularities of splitting of the target text correspond to lengths of keywords stored in the local text database. The splitting of the target text may be achieved by any text splitting method available in the prior art, which is not specifically limited in the embodiment.

At block S203, the at least two target keywords are matched with the local text database respectively to determine preset keywords corresponding to the target keywords.

At block S204, the output speech of the target text is determined, based on the preset keywords, from the local speech database to output the output speech.

Still taking the above example as an example, after splitting “turn left on the road ahead”, the preset keywords “turn left”, “on the road”, and “ahead” are matched in the local text database. The output speech of the target text is determined based on the preset keywords. In detail, a plurality of speech fragments that only contain the preset keywords matched based on the preset keywords may be spliced to obtain the final output speech; or speech cutting may be performed on speech segments containing the preset keywords and other words matched based on the preset keywords to remove parts corresponding to other words, and then speech segments obtained after the speech cutting may be spliced to obtain the final output speech.

According to the embodiment of the present disclosure, both an overall matching of the target text and keyword matching after the target text is split are supported. Through refinement of granularity of word segmentation, a success rate of determining the output speech of the target text through local text matching is raised, requirements of the local text matching on the output speech in the offline state are ensured to be satisfied, and the output speech in the offline state is optimized.

Illustratively, determining, based on the preset keywords, the output speech of the target text from the local speech database includes: determining, based on the preset keywords, speech segments corresponding to the target keywords from the local speech database; and splicing the speech segments based on a sequence of the target keywords in the target text, to obtain the output speech of the target text.

If preset keywords identical to the target keywords may be matched from the local text database, it means that there are speech segments corresponding to the target keywords in the local speech database, such that the output speech may be obtained by splicing the speech segments based on the sequence of the target keywords in the text. If a target keyword cannot match with any preset keyword, it may be determined based on a preset rule whether to directly activate the offline text to speech method integrated on the interaction device to perform text to speech processing on the target text. The preset rule may be flexibly set according to the activation of the offline text to speech method.

For example, if a number of target keywords that cannot match with any preset keyword is less than a number threshold, the offline text to speech method may be adopted to perform text to speech processing on the target keywords that cannot match with any preset keyword, while the local speech database is still adopted for successfully matched target keywords to determine corresponding speech segments, such that the output speech of the target text is determined in an integrated approach. If a number of target keywords that cannot match with any preset keyword is greater than or equal to the number threshold, the offline text to speech method may be adopted to perform text to speech processing on the entire target text. Of course, in the embodiment, when it is determined that there is a target keyword that cannot be matched with any preset keyword, the offline text to speech method may be adopted to perform the text to speech processing on the entire target text.

With the technical solution according to the embodiment, in offline speech interaction scenes, the local text database is preferably used for text matching. If a preset text cannot be matched for the entire target text, the output speech may be determined through the keyword matching. The preset local speech database stores the high-quality human speech. In addition, the solution according to the embodiment does not directly enable the offline text to speech. Therefore, the solution according to the embodiment solves a problem of a mechanical sense of speech outputted in the offline state through the offline text to speech manner, optimizes the output speech when a device supporting speech interaction is in the offline state, improves the anthropomorphic level of the output speech, and reduces the impact of the mechanical speech on the user experience. In addition, the speech segments are spliced based on an appearance order of words in the text to obtain the final output speech, such that the correctness of the output speech is ensured.

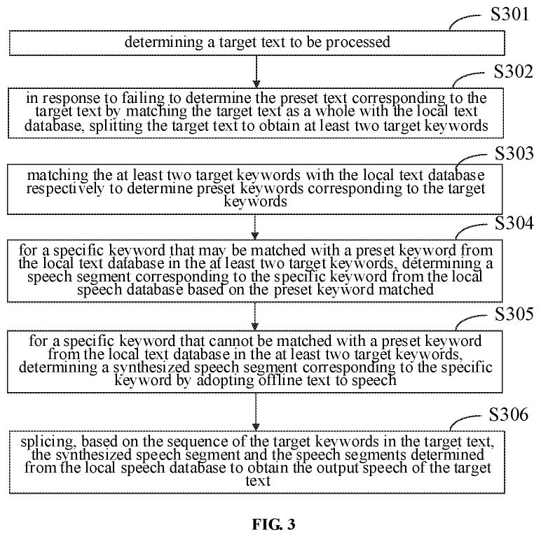

FIG. 3 is a flowchart of a speech output method according to yet another embodiment of the present disclosure, which is further optimized and expanded based on the above technical solution, and may be combined with the above optional implementations. As illustrated in FIG. 3, the method may include the following.

At block S301, a target text to be processed is determined.

At block S302, in response to failing to determine the preset text corresponding to the target text by matching the target text as a whole with the local text database, the target text is split to obtain at least two target keywords.

At block S303, the at least two target keywords are matched with the local text database respectively to determine preset keywords corresponding to the target keywords.

At block S304, for a specific keyword that may be matched with a preset keyword from the local text database in the at least two target keywords, a speech segment corresponding to the specific keyword may be determined from the local speech database based on the preset keyword matched.

At block S305, for a specific keyword that fails to match with a preset keyword from the local text database in the at least two target keywords, a synthesized speech segment corresponding to the specific keyword is determined by adopting offline text to speech.

In the embodiment, only the offline text to speech method is enabled to perform text to speech processing on a target keyword that has not been successfully matched. In addition, there is no strict limitation on an execution order of block S304 to block S305, and the execution order illustrated in FIG. 3 should not be understood as a specific limitation to the embodiment.

At block S306, the synthesized speech segment and the speech segment determined from the local speech database are spliced, based on the sequence of the target keywords in the target text, to obtain the output speech of the target text.

With the technical solution according to the embodiment, the target text is split in offline speech interaction scenes. The local text database and the local speech database are used to match speech segments of some target keywords, and the offline text to speech method is adopted to perform text to speech processing on other target keywords to determine the output speech of the target text in an integrated approach. Compared with scenes of pure mechanical speech output, such a solution optimizes offline speech of the interaction device, solves a problem of a mechanical and rigid sense of the speech outputted in the offline state through the offline text to speech method, improves an anthropomorphic level of the output speech, and mitigates the impact of mechanical speech on the user experience. In addition, the output speech of the target text determined through a combination of the local text matching and the offline text to speech method includes two types of speech, that is, a mixture of partly humanized speech and partly mechanical speech, which may achieve certain speech emphasis effect. For example, when the target text “go straight ahead for 100 meters” is split and a corresponding speech segment cannot be determined from the local speech database, a synthesized speech segment may be obtained by the offline text to speech method, so that after the interaction device outputs the speech, an effect of emphasizing the distance “100 meters” may be achieved.

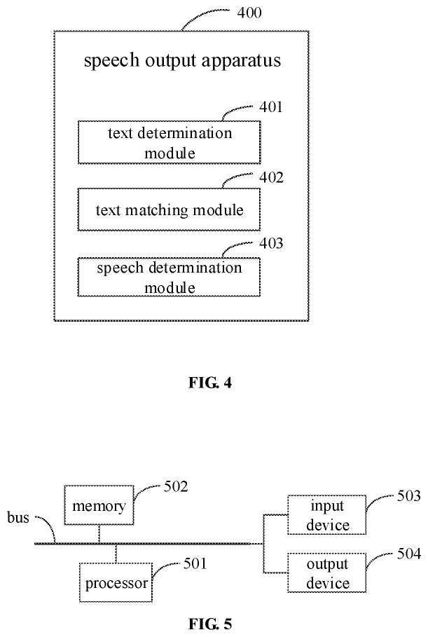

FIG. 4 is a schematic diagram of a speech output apparatus according to an embodiment of the present disclosure. The embodiment may be applied to a situation where an interaction device may output human speech or human-like speech in offline speech interaction. The apparatus according to the embodiment may be executed by software and/or hardware, and may be integrated on any electronic device that has computing capabilities and supports speech interaction functions, such as a mobile terminal, a smart speaker, a vehicle-mounted terminal, and so on. The vehicle-mounted terminal includes an in-vehicle terminal.

As illustrated in FIG. 4, a speech output apparatus 400 according to the embodiment may include a text determination module 401, a text matching module 402, and a speech determination module 403. The text determination module 401 is configured to determine a target text to be processed. The text matching module 402 is configured to determine a preset text corresponding to the target text by matching the target text with a local text database. The speech determination module 403 is configured to determine, based on the preset text, output speech of the target text from a local speech database to output the output speech. The local speech database is pre-configured based on a correspondence between a text and speech.

Optionally, the text matching module 402 includes a text splitting unit and a keyword matching unit. The text splitting unit is configured to, in response to failing to determine the preset text corresponding to the target text by matching the target text as a whole with the local text database, split the target text to obtain at least two target keywords. The keyword matching unit is configured to match the at least two target keywords with the local text database respectively to determine preset keywords corresponding to the target keywords. Correspondingly, the speech determination module 403 is configured to determine, based on the preset keywords, the output speech of the target text from the local speech database.

Optionally, the speech determination module 403 includes a speech segment determination unit and a first speech splicing unit. The speech segment determination unit is configured to determine, based on the preset keywords, speech segments corresponding to the target keywords from the local speech database. The first speech splicing unit is configured to splice, based on a sequence of the target keywords in the target text, the speech segments to obtain the output speech of the target text.

Optionally, the speech determination module 403 includes an offline text-to-speech unit and a second speech splicing unit. The offline text-to-speech unit is configured to, for a specific keyword that fails to match with a preset keyword from the local text database in the at least two target keywords, determine a synthesized speech segment corresponding to the specific keyword by adopting offline text to speech. The second speech splicing unit is configured to splice, based on the sequence of the target keywords in the target text, the synthesized speech segment and the speech segment determined from the local speech database to obtain the output speech of the target text.

Optionally, the speech output apparatus according to the embodiment of the present disclosure is configured to perform a speech output method applied to an offline navigation scene. The local speech database includes navigation terms.

The speech output apparatus 400 according to the embodiment of the present disclosure may perform the speech output method according to any embodiment of the present disclosure, and has corresponding functional modules for performing the method and beneficial effects. For content not described in detail in the embodiment, reference may be made to the description in any method embodiment of the present disclosure.

According to embodiments of the present disclosure, an electronic device and a readable storage medium are provided.

FIG. 5 is a block diagram of an electronic device configured to implement a speech output method according to an embodiment of the present disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. Components shown herein, their connections and relationships as well as their functions are merely examples, and are not intended to limit the implementation of the present disclosure described and/or required herein.

As illustrated in FIG. 5, the electronic device includes: one or more processors 501, a memory 502, and interfaces for connecting various components, including a high-speed interface and a low-speed interface. The components are interconnected by different buses and may be mounted on a common motherboard or otherwise installed as required. The processor may process instructions executed within the electronic device, including instructions stored in or on the memory to display graphical information of the GUI on an external input/output device (such as a display device coupled to the interface). In other embodiments, when necessary, multiple processors and/or multiple buses may be used with multiple memories. Similarly, multiple electronic devices may be connected, each providing some of the necessary operations (for example, as a server array, a group of blade servers, or a multiprocessor system). One processor 501 is taken as an example in FIG. 5.

The memory 502 is a non-transitory computer-readable storage medium according to embodiments of the present disclosure. The memory stores instructions executable by at least one processor, so that the at least one processor executes the speech output method according to embodiments of the present disclosure. The non-transitory computer-readable storage medium according to the present disclosure stores computer instructions, which are configured to make the computer execute the speech output method according to embodiments of the present disclosure.

As a non-transitory computer-readable storage medium, the memory 502 may be configured to store non-transitory software programs, non-transitory computer executable programs and modules, such as program instructions/modules (for example, the data obtaining module 601, the vehicle fault determination module 602 and the warning sign placement module 603 shown in FIG. 6) corresponding to the vehicle fault processing method according to embodiments of the present disclosure. The processor 501 executes various functional applications and performs data processing of the server by running non-transitory software programs, instructions and modules stored in the memory 502, that is, the speech output method according to the foregoing method embodiments is implemented.

The memory 502 may include a storage program area and a storage data area, where the storage program area may store an operating system and applications required for at least one function; and the storage data area may store data created according to the use of the electronic device that implements the speech output method, and the like. In addition, the memory 502 may include a high-speed random access memory, and may further include a non-transitory memory, such as at least one magnetic disk memory, a flash memory device, or other non-transitory solid-state memories. In some embodiments, the memory 502 may optionally include memories remotely disposed with respect to the processor 501, and these remote memories may be connected to the electronic device, which is configured to implement the speech output method according to embodiments of the present disclosure, through a network. Examples of the network include, but are not limited to, the Internet, an intranet, a local area network, a mobile communication network, and combinations thereof.

The electronic device configured to implement the speech output method according to embodiments of the present disclosure may further include an input device 503 and an output device 504. The processor 501, the memory 502, the input device 503 and the output device 504 may be connected through a bus or in other manners. FIG. 5 is illustrated by establishing the connection through a bus.

The input device 503 may receive input numeric or character information, and generate key signal inputs related to user settings and function control of the electronic device configured to implement the speech output method according to embodiments of the present disclosure, such as a touch screen, a keypad, a mouse, a trackpad, a touchpad, a pointing stick, one or more mouse buttons, trackballs, joysticks and other input devices. The output device 504 may include a display device, an auxiliary lighting device (for example, an LED), a haptic feedback device (for example, a vibration motor), and so on. The display device may include, but is not limited to, a liquid crystal display (LCD), a light emitting diode (LED) display and a plasma display. In some embodiments, the display device may be a touch screen.

Various implementations of systems and technologies described herein may be implemented in digital electronic circuit systems, integrated circuit systems, application-specific ASICs (application-specific integrated circuits), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device and the at least one output device.

These computing programs (also known as programs, software, software applications, or codes) include machine instructions of a programmable processor, and may implement these calculation procedures by utilizing high-level procedures and/or object-oriented programming languages, and/or assembly/machine languages. As used herein, terms “machine-readable medium” and “computer-readable medium” refer to any computer program product, device and/or apparatus configured to provide machine instructions and/or data to a programmable processor (for example, a magnetic disk, an optical disk, a memory and a programmable logic device (PLD)), and includes machine-readable media that receive machine instructions as machine-readable signals. The term “machine-readable signals” refers to any signal used to provide machine instructions and/or data to a programmable processor.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to provide interactions with the user; for example, the feedback provided to the user may be any form of sensory feedback (e.g., visual feedback, auditory feedback or haptic feedback); and input from the user may be received in any form (including acoustic input, voice input or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components or the front-end components. The components of the system may be interconnected by digital data communication (e.g., a communication network) in any form or medium. Examples of the communication network include: a local area network (LAN), a wide area network (WAN), and the Internet.

Computer systems may include a client and a server. The client and server are generally remote from each other and typically interact through the communication network. A client-server relationship is generated by computer programs running on respective computers and having a client-server relationship with each other.

With the technical solution according to embodiments of the present disclosure, in offline speech interaction scenes, the local text database is preferably used for text matching to determine the preset text, and then the preset text is used to determine the output speech from the local speech database. The preset local speech database stores the high-quality human speech. In addition, the solution according to embodiments of the present disclosure does not directly enable the offline text to speech. Therefore, the solution according to embodiments of the present disclosure solves a problem of a mechanical sense of speech outputted in the offline state through the offline text to speech manner, optimizes the output speech when a device supporting speech interaction is in the offline state, improves the anthropomorphic level of the output speech, and reduces the impact of the mechanical speech on the user experience.

It should be understood that various forms of processes shown above may be reordered, added or deleted. For example, the blocks described in the present disclosure may be executed in parallel, sequentially, or in different orders. As long as the desired results of the technical solution disclosed in the present disclosure may be achieved, there is no limitation herein.

The foregoing specific implementations do not constitute a limit on the protection scope of the present disclosure. It should be understood by those skilled in the art that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A speech output method, comprising:
determining a target text to be processed;
determining a preset text corresponding to the target text by matching the target text with a local text database; and
determining, based on the preset text, output speech of the target text from a local speech database to output the output speech;
wherein the local speech database is pre-configured based on a correspondence between a text and speech.

2. The method of claim 1, wherein determining the preset text corresponding to the target text by matching the target text with the local text database comprises:
in response to failing to determine the preset text corresponding to the target text by matching the target text as a whole with the local text database, splitting the target text to obtain at least two target keywords; and
matching the at least two target keywords with the local text database respectively to determine preset keywords corresponding to the target keywords; and
determining, based on the preset text, the output speech of the target text from the local speech database comprises:
determining, based on the preset keywords, the output speech of the target text from the local speech database.

3. The method of claim 2, wherein determining, based on the preset keywords, the output speech of the target text from the local speech database comprises:
determining, based on the preset keywords, speech segments corresponding to the target keywords from the local speech database; and
splicing the speech segments based on a sequence of the target keywords in the target text, to obtain the output speech of the target text.

4. The method of claim 3, wherein determining, based on the preset keywords, the output speech of the target text from the local speech database comprises:
for a specific keyword that fails to match with a preset keyword from the local text database in the at least two target keywords, determining a synthesized speech segment corresponding to the specific keyword by adopting offline text to speech; and
splicing, based on the sequence of the target keywords in the target text, the synthesized speech segment and the speech segment determined from the local speech database to obtain the output speech of the target text.

5. The method of claim 1, which is applied to an offline navigation scene,
wherein the local speech database comprises navigation terms.

6. An electronic device, comprising:
at least one processor; and
a storage device communicatively connected to the at least one processor; wherein,
the storage device stores an instruction executable by the at least one processor, and when the instruction executed by the at least one processor, the processor implements a speech output method, and the speech output method comprises:
determining a target text to be processed;
determining a preset text corresponding to the target text by matching the target text with a local text database; and
determining, based on the preset text, output speech of the target text from a local speech database to output the output speech;
wherein the local speech database is pre-configured based on a correspondence between a text and speech.

7. The electronic device of claim 6, wherein determining the preset text corresponding to the target text by matching the target text with the local text database comprises:
in response to failing to determine the preset text corresponding to the target text by matching the target text as a whole with the local text database, splitting the target text to obtain at least two target keywords; and
matching the at least two target keywords with the local text database respectively to determine preset keywords corresponding to the target keywords; and
determining, based on the preset text, the output speech of the target text from the local speech database comprises:
determining, based on the preset keywords, the output speech of the target text from the local speech database.

8. The electronic device of claim 7, wherein determining, based on the preset keywords, the output speech of the target text from the local speech database comprises:
determining, based on the preset keywords, speech segments corresponding to the target keywords from the local speech database; and
splicing the speech segments based on a sequence of the target keywords in the target text, to obtain the output speech of the target text.

9. The electronic device of claim 8, wherein determining, based on the preset keywords, the output speech of the target text from the local speech database comprises:
for a specific keyword that fails to match with a preset keyword from the local text database in the at least two target keywords, determining a synthesized speech segment corresponding to the specific keyword by adopting offline text to speech; and
splicing, based on the sequence of the target keywords in the target text, the synthesized speech segment and the speech segment determined from the local speech database to obtain the output speech of the target text.

10. The electronic device of claim 6, wherein the local speech database comprises navigation terms.

11. A non-transitory computer-readable storage medium having a computer instruction stored thereon, wherein the computer instruction is configured to make a computer implement a speech output method, and the speech output method comprises:
determining a target text to be processed;
determining a preset text corresponding to the target text by matching the target text with a local text database; and
determining, based on the preset text, output speech of the target text from a local speech database to output the output speech;
wherein the local speech database is pre-configured based on a correspondence between a text and speech,

12. The storage medium of claim 11, wherein determining the preset text corresponding to the target text by matching the target text with the local text database comprises:
in response to failing to determine the preset text corresponding to the target text by matching the target text as a whole with the local text database, splitting the target text to obtain at least two target keywords; and
matching the at least two target keywords with the local text database respectively to determine preset keywords corresponding to the target keywords; and
determining, based on the preset text, the output speech of the target text from the local speech database comprises:
determining, based on the preset keywords, the output speech of the target text from the local speech database.

13. The storage medium of claim 12, wherein determining, based on the preset keywords, the output speech of the target text from the local speech database comprises:
determining, based on the preset keywords, speech segments corresponding to the target keywords from the local speech database; and
splicing the speech segments based on a sequence of the target keywords in the target text, to obtain the output speech of the target text.

14. The storage medium of claim 13, wherein determining, based on the preset keywords, the output speech of the target text from the local speech database comprises:
for a specific keyword that fails to match with a preset keyword from the local text database in the at least two target keywords, determining a synthesized speech segment corresponding to the specific keyword by adopting offline text to speech; and
splicing, based on the sequence of the target keywords in the target text, the synthesized speech segment and the speech segment determined from the local speech database to obtain the output speech of the target text.

15. The storage medium of claim 11, wherein the local speech database comprises navigation terms.
